(19) United States
(12) Patent Application Publication
(10) Pub. No.: US 2025/0392773 A1
(43) Pub. Date: Dec. 25, 2025

(54) System and Method for Prioritizing Various Non-Real-Time (NRT) Data Services within an ATSC 3.0 Broadcasting Standard

(71) Applicant: Anywave Communication Technologies Inc., Vernon Hills, IL (US)

(72) Inventors: Yingying Fan, Hawthorn Woods, IL (US); Pan Xia, Hawthorn Woods, IL (US); Bowei Song, Hawthorn Woods, IL (US); Jingsong Xia, Hawthorn Woods, IL (US); Edward Karam, West Suffield, CT (US)

(21) Appl. No.: 19/247,709

(22) Filed: Jun. 24, 2025

Related U.S. Application Data
(60) Provisional application No. 63/663,383, filed on Jun. 24, 2024.

(51) Int. Cl. H04N 21/262; H04N 21/222; H04N 21/234; H04N 21/488

(52) U.S. Cl. CPC H04N 21/262; H04N 21/222; H04N 21/23406; H04N 21/488

(57) ABSTRACT

A system for prioritizing NRT data services within an ATSC 3.0 broadcasting standard includes NRT servers each configured to transmit NRT data; a signaling server operatively coupled to each of the NRT servers and configured to receive the NRT data and prioritize the received NRT data; and a broadcast gateway operatively coupled to the signaling server and configured to receive the prioritized NRT data from the signaling server and convert the prioritized NRT data for transmission to an exciter for ATSC 3.0 broadcasting. The signaling server includes a processor configured to prioritize the received NRT data to produce the prioritized NRT data by: defining a prioritization policy; identifying priorities of the received NRT data and assigning priority according to the prioritization policy across all of the received NRT data; and determining a priority schedule for broadcasting the received NRT data to provide the prioritized NRT data to the broadcast gateway.

### CROSS-REFERENCE TO RELATED APPLICATION

This application claims priority to U.S. Patent Application No. 63/663,383, filed Jun. 24, 2024, the disclosure of which is hereby incorporated by reference in its entirety.

### BACKGROUND

### 1. Field

This disclosure relates generally to digital television broadcasting, and, in some non-limiting embodiments or aspects, to the prioritization of diverse Non-Real Time (NRT) data types, such as Electronic Service Guide (ESG) data, Advanced Emergency Alert (AEA)-related data, application-based service data, etc., to ensure streamlined transmission and reception within the Advanced Television Systems Committee (ATSC) 3.0 standard.

### 2. Description of Related Art

The ATSC 3.0 broadcast standard for over the air delivery of television and other signals is being rolled out across the United States. This new standard offers significant improvements over the previous ATSC 1.0 standard, including support for Ultra-High-Definition (UHD) video, High Dynamic Range (HDR) content, and advanced audio codecs.

The advent of ATSC 3.0 has ushered in advancements in video and audio quality, interactive content, and enhanced data transmission capabilities in digital television broadcasting. However, a need exists for a system and method for efficiently prioritizing various NRT data, including ESG data, AEA-related data, and application-based service data, which is indispensable for optimizing bandwidth utilization and promptly delivering critical information to end users.

### SUMMARY

Accordingly, provided is a system and method for prioritizing various NRT data services within the ATSC 3.0 broadcasting standard. Focusing on critical NRT data types like ESG data, AEA-related data, and app-based services. The system and method of the present disclosure assigns priorities based on urgency, relevance, and criticality.

According to non-limiting embodiments or aspects, provided is a system for prioritizing Non-Real-Time (NRT) data services within an Advanced Television Systems Committee (ATSC) 3.0 broadcasting standard. The system comprising: a plurality of NRT servers each configured to prepare and transmit NRT data in a ATSC 3.0 compliant format; a signaling server operatively coupled to each of the plurality of NRT servers and configured to receive the NRT data in the ATSC 3.0 compliant format and prioritize the received NRT data to produce prioritized NRT data; and a broadcast gateway operatively coupled to the signaling server and configured to receive the prioritized NRT data from the signaling server and convert the prioritized NRT data for transmission to an exciter for ATSC 3.0 broadcasting. The signaling server comprises at least one processor configured to prioritize the received NRT data to produce the prioritized NRT data by: defining a prioritization policy; identifying priorities of the received NRT data and assigning priority according to the prioritization policy across all of the received NRT data; and determining a priority schedule for broadcasting the received NRT data to provide the prioritized NRT data to the broadcast gateway.

In some non-limiting embodiments or aspects, each of the plurality of NRT servers may be configured to define and queue a data priority and a bit rate of the NRT data prepared thereby.

In some non-limiting embodiments or aspects, the plurality of NRT servers may comprise two or more of: an Electronic Service Guide (ESG) server, an Advanced Emergency Alert (AEA), and an application-based services server.

In some non-limiting embodiments or aspects, defining the prioritization policy may comprise designating a specific data type as having a highest priority.

In some non-limiting embodiments or aspects, the prioritization policy may be set by a user.

In some non-limiting embodiments or aspects, the prioritization policy may be determined by the at least one processor of the signaling server.

In some non-limiting embodiments or aspects, the at least one processor of the signaling server may assign priority according to the prioritization policy across all of the received NRT data by employing a pre-existing reserved byte in the received NRT data as a priority byte and assigning code values with each code value representing a specific priority level.

In some non-limiting embodiments or aspects, the priority byte may provide buffer control to prioritize urgent data for immediate transmission.

According to non-limiting embodiments or aspects, provided is a method of prioritizing Non-Real-Time (NRT) data services within an Advanced Television Systems Committee (ATSC) 3.0 broadcasting standard. The method comprises: preparing and transmitting NRT data in a ATSC 3.0 compliant format with a plurality of NRT servers; receiving the NRT data in the ATSC 3.0 compliant format with a signaling server; defining a prioritization policy with the signaling server; identifying priorities of the received NRT data and assigning priority according to the prioritization policy across all of the received NRT data with the signaling server; determining a priority schedule for broadcasting the received NRT data to provide prioritized NRT data to a broadcast gateway; receiving the prioritized NRT data from the signaling server with the broadcast gateway; and converting the prioritized NRT data for transmission to an exciter for ATSC 3.0 broadcasting.

In some non-limiting embodiments or aspects, each of the plurality of NRT servers may be configured to define and queue a data priority and a bit rate of the NRT data prepared thereby.

In some non-limiting embodiments or aspects, the plurality of NRT servers may comprise two or more of: an Electronic Service Guide (ESG) server, an Advanced Emergency Alert (AEA), and an application-based services server.

In some non-limiting embodiments or aspects, defining the prioritization policy may comprise designating a specific data type as having a highest priority.

In some non-limiting embodiments or aspects, the prioritization policy may be set by a user.

In some non-limiting embodiments or aspects, the prioritization policy may be determined by a processor of the signaling server.

In some non-limiting embodiments or aspects, assigning priority according to the prioritization policy across all of the received NRT data may comprise employing a pre-existing reserved byte in the received NRT data as a priority byte and assigning code values with each code value representing a specific priority level.

Further non-limiting embodiments or aspects are set forth in the following numbered clauses:
Clause 1: A system for prioritizing Non-Real-Time (NRT) data services within an Advanced Television Systems Committee (ATSC) 3.0 broadcasting standard, the system comprising: a plurality of NRT servers each configured to prepare and transmit NRT data in a ATSC 3.0 compliant format; a signaling server operatively coupled to each of the plurality of NRT servers and configured to receive the NRT data in the ATSC 3.0 compliant format and prioritize the received NRT data to produce prioritized NRT data; and a broadcast gateway operatively coupled to the signaling server and configured to receive the prioritized NRT data from the signaling server and convert the prioritized NRT data for transmission to an exciter for ATSC 3.0 broadcasting, wherein the signaling server comprises at least one processor configured to prioritize the received NRT data to produce the prioritized NRT data by: defining a prioritization policy; identifying priorities of the received NRT data and assigning priority according to the prioritization policy across all of the received NRT data; and determining a priority schedule for broadcasting the received NRT data to provide the prioritized NRT data to the broadcast gateway.
Clause 2: The system of clause 1, wherein each of the plurality of NRT servers is configured to define and queue a data priority and a bit rate of the NRT data prepared thereby.
Clause 3: The system of clause 1 or clause 2, wherein the plurality of NRT servers comprise two or more of: an Electronic Service Guide (ESG) server, an Advanced Emergency Alert (AEA), and an application-based services server.
Clause 4: The system of any of clauses 1-3, wherein defining the prioritization policy comprises designating a specific data type as having a highest priority.
Clause 5: The system of any of clauses 1-4, wherein the prioritization policy is set by a user.
Clause 6: The system of any of clauses 1-5, wherein the prioritization policy is determined by the at least one processor of the signaling server.
Clause 7: The system of any of clauses 1-6, wherein the at least one processor of the signaling server assigns priority according to the prioritization policy across all of the received NRT data by employing a pre-existing reserved byte in the received NRT data as a priority byte and assigning code values with each code value representing a specific priority level.
Clause 8: The system of clause 7, wherein the priority byte provides buffer control to prioritize urgent data for immediate transmission.
Clause 9: A method of prioritizing Non-Real-Time (NRT) data services within an Advanced Television Systems Committee (ATSC) 3.0 broadcasting standard, the method comprising: preparing and transmitting NRT data in a ATSC 3.0 compliant format with a plurality of NRT servers; receiving the NRT data in the ATSC 3.0 compliant format with a signaling server; defining a prioritization policy with the signaling server; identifying priorities of the received NRT data and assigning priority according to the prioritization policy across all of the received NRT data with the signaling server; determining a priority schedule for broadcasting the received NRT data to provide prioritized NRT data to a broadcast gateway; receiving the prioritized NRT data from the signaling server with the broadcast gateway; and converting the prioritized NRT data for transmission to an exciter for ATSC 3.0 broadcasting.
Clause 10: The method of clause 9, wherein each of the plurality of NRT servers is configured to define and queue a data priority and a bit rate of the NRT data prepared thereby.
Clause 11: The method of clause 9 or clause 10, wherein the plurality of NRT servers comprise two or more of: an Electronic Service Guide (ESG) server, an Advanced Emergency Alert (AEA), and an application-based services server.
Clause 12: The method of any of clauses 9-11, wherein defining the prioritization policy comprises designating a specific data type as having a highest priority.
Clause 13: The method of any of clauses 9-12, wherein the prioritization policy is set by a user.
Clause 14: The method of any of clauses 9-13, wherein the prioritization policy is determined by a processor of the signaling server.
Clause 15: The method of any of clauses 9-14, wherein assigning priority according to the prioritization policy across all of the received NRT data comprises employing a pre-existing reserved byte in the received NRT data as a priority byte and assigning code values with each code value representing a specific priority level.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosed subject matter.

### BRIEF DESCRIPTION OF THE DRAWINGS

Additional advantages and details of the disclosed subject matter are explained in greater detail below with reference to the exemplary embodiments that are illustrated in the accompanying figures, in which:

FIG. 1 is a block diagram of a system for prioritizing NRT data services within an ATSC 3.0 broadcasting standard, according to some non-limiting embodiments or aspects; and

FIG. 2 is an exemplary Advanced Emergency Alert (AEA) priority table.

### DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the embodiments as they are oriented in the drawing figures. However, it is to be understood that the present disclosure may assume various alternative variations and step sequences, except where expressly specified to the contrary. It is also to be understood that the specific devices and processes illustrated in the attached drawings, and described in the following specification, are simply exemplary and non-limiting embodiments or aspects of the disclosed subject matter. Hence, specific dimensions and other physical characteristics related to the embodiments or aspects disclosed herein are not to be considered as limiting.

Some non-limiting embodiments or aspects are described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Furthermore, as used herein, the term “set” is intended to include one or more items (e.g., related items, unrelated items, a combination of related and unrelated items, and/or the like) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise. In addition, reference to an action being “based on” a condition may refer to the action being “in response to” the condition. For example, the phrases “based on” and “in response to” may, in some non-limiting embodiments or aspects, refer to a condition for automatically triggering an action (e.g., a specific operation of an electronic device, such as a computing device, a processor, and/or the like).

As used herein, the term “communication” may refer to the reception, receipt, transmission, transfer, provision, and/or the like of data (e.g., information, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection (e.g., a direct communication connection, an indirect communication connection, and/or the like) that is wired and/or wireless in nature.

Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit processes information received from the first unit and provides or communicates the processed information to the second unit. In some non-limiting embodiments or aspects, a message may refer to a network packet (e.g., a data packet and/or the like) that includes data. It will be appreciated that numerous other arrangements are possible.

As used herein, the term “computing device” may refer to one or more electronic devices configured to process data. A computing device may, in some examples, include the necessary components to receive, process, and output data, such as a processor, a display, a memory, an input device, a network interface, and/or the like. A computing device may be a mobile device. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. A computing device may also be a desktop computer or other form of non-mobile computer.

Some non-limiting embodiments or aspects of the present disclosure may provide a system and method for prioritizing various Non-Real-Time (NRT) data services within the ATSC 3.0 broadcasting standard. Focusing on critical NRT data types like ESG data, AEA-related data, and app-based services, the system and method of the present disclosure assigns priorities based on urgency, relevance, and criticality.

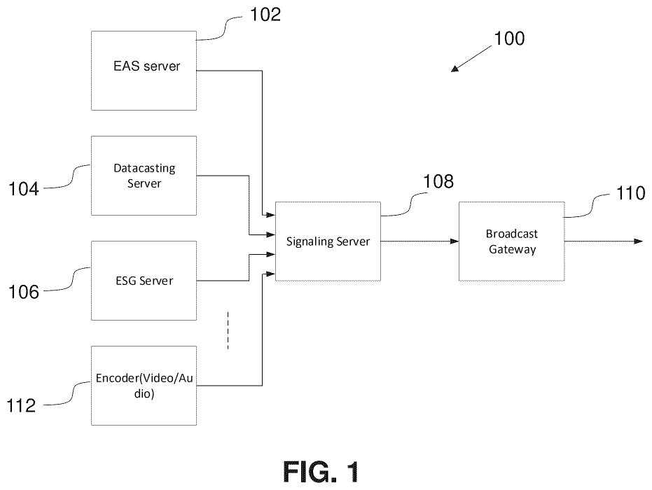

Referring now to FIG. 1, system 100 comprises individual servers for different NRT data services, such as, but not limited to an EAS Server 102, a Datacasting Server 104 providing data from app-based services, and an ESG Server 106. The system 100 may further include a Signaling Server 108 for multiplexing various data including prioritizing NRT and a Broadcast Gateway 110 for generating packets for ATSC 3.0 broadcasting. In certain implementations, an encoder 112 may be provided as an input to the Signaling Server 108 to as an input of audio and video real-time media contents to the Signaling Server 108 to be combined with the NRT data.

In some non-limiting embodiments or aspects, each of the above-described servers or circuitry may be implemented by one or more computing devices and/or one or more processors and memory. In some non-limiting embodiments or aspects, the one or more processors may be implemented in hardware, firmware, or a combination of hardware and software. For example, the one or more processors may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), a device configured to implement logic functions, etc.) that can be programmed to perform a function. The memory may include random access memory (RAM), read-only memory (ROM), and/or another type of dynamic or static storage memory (e.g., flash memory, magnetic memory, optical memory, etc.) that stores information and/or instructions for use by the one or more processors.

With continued reference to FIG. 1, for various NRT data services, including ESG, AEA, and app-based services, each type has a dedicated server 106, 102, and 104, respectively, that is configured to receive, prepare, and queue the data for transmission to an ATSC 3.0 link. The output data from each data server 102, 104, and 106 is directed to the Signaling Server 108. The Signaling Server 108 receives various data contents from the different servers 102, 104, and 106, multiplexes these data (AEA, ESG, etc.) together with media content received from the encoder 112, and routes the combined output to the Broadcast Gateway 110. The Broadcast Gateway 110 receives the data from the Signaling Server 108, generates ATSC 3.0 Link-Layer Protocol (ALPs), then converts them into Baseband Packet (BBPs), and finally into Physical Layer Pipes (PLPs) for transmission to an exciter for ATSC 3.0 broadcasting.

In the data servers 102, 104, and 106, certain functions may be executed that are not exclusively or specifically designed for ATSC 3.0, as long as these servers can produce data in an ATSC 3.0 compliant format. Accordingly, the data servers 102, 104, and 106 may be existing, conventional data servers. Other functions can be implemented and integrated into the ATSC 3.0 Signaling Server 108. Among the functions performed by data servers 102, 104, and 106 is programming to process and queue input data based on preset rules or policies, in addition to configuring their output bitrate. In one non-limiting, the Emergency Alert System (EAS) server 102 can receive emergency messages from various sources, applying a predefined policy to establish data priority, output queue, and output rate. Another function involves providing different data types, like emergency messages (to become AEA in ATSC 3.0) and their associated rich media files (to become an NRT file in ATSC 3.0), along with links between them. This function can be executed by the EAS server 102 supporting the ATSC 3.0 feature or by the Signaling Server 108 after receiving the data from the data server, offering flexible implementation. Similarly, ESG data requires linking with its corresponding media contents for synchronized presentation.

However, each data server 102, 104, and 106 is confined to setting priorities within its specific data type. For instance, the EAS server 102 solely manages the processing of AEA messages and defines priorities, output queues, and rates for AEA messages, without influencing the operation of the ESG server 106. The independent operation of the various data servers 102, 104, and 106 results in the multiplexing step in the Signaling Server 108 losing control over the priority of more urgent data. This underscores the necessity for the Signaling Server 108 to go beyond the common FIFO (first in, first out) policy, implementing the prioritization system and method defined by this disclosure. The disclosure aims to establish and determine priorities across all NRT data types. Although each data server 102, 104, and 106 independently processes data, their roles remain crucial as they provide the Signaling Server 108 with insights into the most urgent data within their specific data type. Moreover, the output queue and rates of prioritized data from each data server 102, 104, and 106 contribute to expediting the transmission of the most urgent data by the Signaling Sever 108 to the subsequent step compared to less critical data.

After the Signaling Server 108 receives diverse data from the different data servers 102, 104, and 106, each having defined and queued their data priority and bit rate, it is now the responsibility of the Signaling Server 108 to collectively prioritize them. This can be done through a user-defined policy or an automatic processing method designed for process optimization. The automatic processing method dynamically adjusts priorities based on real-time conditions and user preferences, thereby enhancing the efficiency of the transmission process. This method is performed by at least one processor provided by the Signaling Server 108. The following outlines the method:

The initial step involves defining the prioritization policy. This policy can be as straightforward as designating a specific data type, like AEA, always has the highest priority. For instance, even if some messages in the AEA category have a low priority rating (e.g., a station notice), a user can simplify the policy by treating all AEA-related data as the highest priority. Alternatively, the policy can be intricate, such as prioritizing AEA data with a priority level of 3-4 as the most important and ensuring that rich media files linked to this priority level 3-4 AEA data are also considered important to arrive simultaneously. Another instance involves the Electronic Service Guide (ESG), which can hold secondary importance if it will be utilized in the subsequent time session along with its associated media contents. Meanwhile, certain app updates, which can afford to wait until a less busy session, can be delayed. This policy can be either a manual setup or an automatic processing method, depending on the user's preference.

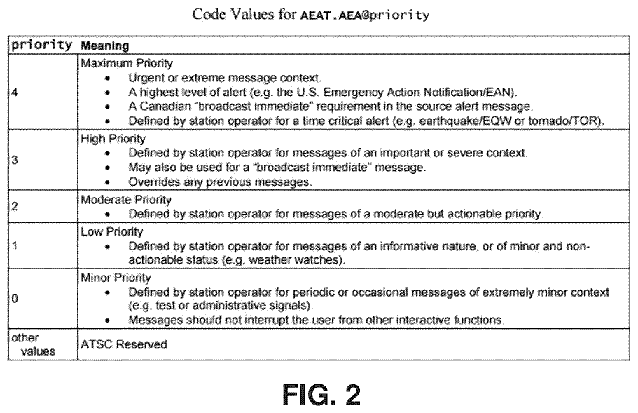

Once the policy is confirmed, the Signaling Server 108 proceeds to analyze and identify priorities among all incoming data, assigning priority according to the predefined policy across all data types. The method of labeling the data or informing other functional blocks, circuitry, or equipment about their priority is determined by the Signaling Server 108. In one exemplary and non-limiting embodiment, the Signaling Sever 108 may employ a pre-existing reserved byte or attribute in the data as a priority byte, assigning code values where each code represents a specific priority level. This method is similar to the AEAT priority table provided in FIG. 2. Once these code values are established, they become recognizable to both the Signaling Server 108 and Broadcast Gateway 110. This enables the Signaling Server 108 and Broadcast Gateway to locate the code and promptly identify the data priority. This process mirrors the example where AEA data possesses an attribute named AEAT.AEA@priority, serving to delineate priorities within all AEA data. Various data types can share a common attribute or have different attributes, allowing for flexibility and adjustment based on data types and standard restrictions. Regardless, the priority label must be inserted into all data contents to define their priorities across the board.

Once the different priorities are established, the Signaling Server 108 devises an optimal strategy for multicasting them into various data source formats, such as ROUTE as defined in the ATSC 3.0 standard. The Signaling Server 108 may group the most urgent data into one or two ROUTE instances, eliminating the need to share the buffer with less urgent data. Alternatively, the Signaling Server 108 can dispatch urgent data as soon as received to the most recent available ROUTE packet, ensuring the minimum processing time for that data. If multiple data types share the same route, the Signaling Server 108, in some non-limiting embodiments, may construct a buffer large enough to accommodate input data from all types but intentionally select the most important data to leave the buffer first, forming the ROUTE packet. This departs from the regular FIFO policy for buffering. The additional label in each data type, incorporated during the priority assignment, empowers buffer control to prioritize the most urgent data for immediate transmission. In this way, the Signaling Server 108 determines a priority schedule for broadcasting the received NRT data to provide the prioritized NRT data to the Broadcast Gateway 110.

The Broadcast Gateway 110 seizes a final opportunity to reassemble various ROUTE data into ALPs during the ALP generator phase. During this step, if further modifications are required, the Broadcast Gateway 110 dissects the components of the original ROUTE data and processes them accordingly to ensure that the most vital and time-sensitive data receives the fastest processing time. The Broadcast Gateway 110 may opt to reserve a dedicated ALP primarily for this crucial data or select the most important data from the input buffering and dispatch it to the most recent available ALP. Through adjustments in ALP allocation and sequences within the ALP, the system and method of the present disclosure ensures that data with the highest priority receives the most immediate processing and is promptly transmitted.

Various advantages are found from the present disclosure and will be discussed hereinafter. For example, the prioritization system and method of the present disclosure provides for an enhanced user experience. The system and method of the present disclosure improves the overall user experience in ATSC 3.0 broadcasts by ensuring timely delivery of critical information, such as Advanced Emergency Alert (AEA) related data, Electronic Service Guide (ESG) data, and other app-based services. In addition, the system and method of the present disclosure allows for efficient bandwidth utilization. For example, the system and method optimizes bandwidth usage by automatically assigning priorities based on urgency, relevance, and allowing for the efficient transmission of NRT data. The system and method of the present disclosure also provides a flexible policy definition approach by allowing users to set prioritization policies manually or utilize an automatic processing method based on the complexity of their broadcasting requirements. The system and method of the present disclosure provides cross-data type prioritization. Unlike conventional systems where each data server independently manages priorities, the system and method of the present disclosure defines and sets priorities across all NRT data types, ensuring a centralized and coherent approach to prioritization. Furthermore, the system and method of the present disclosure allows for the dynamic adjustment of priorities. An automatic processing method as described hereinabove dynamically adjusts priorities based on real-time conditions and user preferences, optimizing the transmission process for enhanced efficiency and adaptability.

Although the disclosed subject matter has been described in detail for the purpose of illustration based on what is currently considered to be the most practical and preferred embodiments, it is to be understood that such detail is solely for that purpose and that the disclosed subject matter is not limited to the disclosed embodiments, but, on the contrary, is intended to cover modifications and equivalent arrangements that are within the spirit and scope of the appended claims. For example, it is to be understood that the presently disclosed subject matter contemplates that, to the extent possible, one or more features of any embodiment can be combined with one or more features of any other embodiment.

What is claimed is:

1. A system for prioritizing Non-Real-Time (NRT) data services within an Advanced Television Systems Committee (ATSC) 3.0 broadcasting standard, the system comprising:
a plurality of NRT servers each configured to prepare and transmit NRT data in a ATSC 3.0 compliant format;
a signaling server operatively coupled to each of the plurality of NRT servers and configured to receive the NRT data in the ATSC 3.0 compliant format and prioritize the received NRT data to produce prioritized NRT data; and
a broadcast gateway operatively coupled to the signaling server and configured to receive the prioritized NRT data from the signaling server and convert the prioritized NRT data for transmission to an exciter for ATSC 3.0 broadcasting,
wherein the signaling server comprises at least one processor configured to prioritize the received NRT data to produce the prioritized NRT data by:
defining a prioritization policy;
identifying priorities of the received NRT data and assigning priority according to the prioritization policy across all of the received NRT data; and
determining a priority schedule for broadcasting the received NRT data to provide the prioritized NRT data to the broadcast gateway.

2. The system of claim 1, wherein each of the plurality of NRT servers is configured to define and queue a data priority and a bit rate of the NRT data prepared thereby.

3. The system of claim 1, wherein the plurality of NRT servers comprise two or more of: an Electronic Service Guide (ESG) server, an Advanced Emergency Alert (AEA), and an application-based services server.

4. The system of claim 1, wherein defining the prioritization policy comprises designating a specific data type as having a highest priority.

5. The system of claim 1, wherein the prioritization policy is set by a user.

6. The system of claim 1, wherein the prioritization policy is determined by the at least one processor of the signaling server.

7. The system of claim 1, wherein the at least one processor of the signaling server assigns priority according to the prioritization policy across all of the received NRT data by employing a pre-existing reserved byte in the received NRT data as a priority byte and assigning code values with each code value representing a specific priority level.

8. The system of claim 7, wherein the priority byte provides buffer control to prioritize urgent data for immediate transmission.

9. A method of prioritizing Non-Real-Time (NRT) data services within an Advanced Television Systems Committee (ATSC) 3.0 broadcasting standard, the method comprising:
preparing and transmitting NRT data in a ATSC 3.0 compliant format with a plurality of NRT servers;
receiving the NRT data in the ATSC 3.0 compliant format with a signaling server;
defining a prioritization policy with the signaling server;
identifying priorities of the received NRT data and assigning priority according to the prioritization policy across all of the received NRT data with the signaling server;
determining a priority schedule for broadcasting the received NRT data to provide prioritized NRT data to a broadcast gateway;
receiving the prioritized NRT data from the signaling server with the broadcast gateway; and
converting the prioritized NRT data for transmission to an exciter for ATSC 3.0 broadcasting.

10. The method of claim 9, wherein each of the plurality of NRT servers is configured to define and queue a data priority and a bit rate of the NRT data prepared thereby.

11. The method of claim 9, wherein the plurality of NRT servers comprise two or more of: an Electronic Service Guide (ESG) server, an Advanced Emergency Alert (AEA), and an application-based services server.

12. The method of claim 9, wherein defining the prioritization policy comprises designating a specific data type as having a highest priority.

13. The method of claim 9, wherein the prioritization policy is set by a user.

14. The method of claim 9, wherein the prioritization policy is determined by a processor of the signaling server.

15. The method of claim 9, wherein assigning priority according to the prioritization policy across all of the received NRT data comprises employing a pre-existing reserved byte in the received NRT data as a priority byte and assigning code values with each code value representing a specific priority level.
